(19) United States
(12) Patent Application Publication
(10) Pub. No.: US 2013/0033640 A1
(43) Pub. Date: Feb. 7, 2013

(54) HANDY SCANNER APPARATUS AND CONTROL METHOD THEREOF

(71) Applicant: Myoung Sool Lee, Ansan (KR)

(72) Inventor: Myoung Sool Lee, Ansan (KR)

(21) Appl. No.: 13/515,822

(22) PCT Filed: Dec. 3, 2010
(86) PCT No.: PCT/KR2010/008630

§ 371 Date: Jun. 14, 2012

(30) Foreign Application Priority Data
Dec. 14, 2009 (KR) 10-2009-0124252

(51) Int. Cl. H04N 5/225

(52) U.S. Cl. 348/376; 348/E05.025

(57) ABSTRACT

The present invention relates to a handy scanner apparatus and a control method thereof, which scan the surface of the object under scan, larger than a scanner, into units of two-dimensional tile images each of which has a predetermined size, and synthesize the photographed images in accordance with shift information into final page images. Particularly, a scan unit comprises: a transparent window portion which forms an area of tile images to be scanned; a housing portion which prevents the introduction of light from an external source; a camera module which maintains a fixed optical distance from the object under scan, and photographs tile images; a lighting module which provides light only during a preset time in accordance with a lighting signal; and a shift sensing module which outputs shift information. According to the present invention, the surface of the object under scan is scanned by units of two-dimensional tile images in which positions of pixels are physically fixed, to thereby achieve improved accuracy of positions of pixels. According to the present invention, the number of arithmetic operations required for image synthesis is reduced, thus enabling high speed signal processing, and the bottom surface of the housing portion can approach closely to the scanning area, thus maximizing a scannable area.

### TECHNICAL FIELD

The present invention relates to a handy (or handheld) scanner, more particularly to a handy (or handheld) scanning device and the control method thereof when scanning an object of which surface is larger than the reading area of the scanner device.

### BACKGROUND ART

A scanner is a device that optically scans any objects and converts the result into a digital image (collectively referred to as “scanner” hereinafter).

A scanner reads an optical image on the surface of an object and converts it into a digital signal for storage or transmission. A scanner can have a wide range of uses in collaboration with digital image processing.

One method commonly used to change an optical image to a digital signal is a linear array of numerous contact image sensors (CIS).

There are two different types of movement sources of a scanner: motor-powered automatic scanners in which the scanning part is moved by an electric motor and manual scanners in which the scanning part is driven by hand.

The present invention relates to a compact handheld scanner, in which the device is moved by hand.

A handheld scanner is equipped with a navigation sensor to track down the direction and the distance when the image sensor travels.

An example of handheld scanners described above is the <Contact Type Image Sensor And Handheld Scanner Using The Same> of Korean Patent Application No. 2000-68664, filed on Nov. 18, 2000.

This conventional scanner captures an image in the form of multiple one-dimensional images and accumulates each linear image to create a two-dimensional image. Due to an excessive amount of generated data, this method may delay the process, limiting the precision when putting linear pixels together. Furthermore, the scanner has a disadvantageous structure which often has a limit on the image size that can be scanned.

FIG. 1 is a diagrammatic view illustrating the components of a handheld scanner according to the related art.

Referring to the accompanying drawing in detail, the handheld scanner (10) with the conventional CIS method comprises a line image sensor (30) on the bottom of a housing (20); and a navigation sensor (40) which computerizes the movement of the scanner.

The housing (20) secures the components including the line image sensor (30) and the navigation sensor (40).

The contact line image sensor (30) comprises a light source that illuminate on the surface of an object; and a linear array of photodiodes and lenses that receive the reflected light from the surface; and a transparent plate which ensures flat contact between the sensor and the object. The contact line image sensor (30) is mounted on the bottom of the housing (20), each edge having distance of <a>, <b>, <c>, and <d> from each facing edge of the housing (20).

Thus, the space between the housing (20) and the contact line image sensor (30) does not allow scanning the underneath thereof when the handheld scanner (10) experiences a physical obstruction.

This crucial problem of the handheld scanner (10) frequently occurs, especially when scanning a book or a pile of documents which are well bound, thus contain uneven surfaces. Any words left out from scanning may disturb understanding the entire context written on the object.

In addition, the limited depth of focus of the line image sensor (30) significantly lowers the quality of the scanning result even if the handheld scanner (10) is slightly apart from the object (generally >0.5 mm)

The navigation sensor (40) is placed on the bottom of the housing (20). It detects the direction and distance when handheld scanner (10) travels.

One-dimensional data captured by the line image sensor (30) are designated to the coordinates calculated from the navigation sensor (40) to compose a two-dimensional image.

Hence, such a process in which linear images are stitched to create a two-dimensional image is fairly time consuming and it is troublesome to precisely position each pixel at each desired coordinates.

FIG. 2 is a flowchart for processing scanned image data according to the related art.

Scanned images from the line image sensor (20) in collaboration with the navigation sensor (50) experience a set of procedure comprising scanning (S10), stitching line images (S20), and stitching tile images (S30);

At the scanning step (S10), a control unit of which diagram is not included below collects line images (S12) from the line image sensor (30), converts movement data from the navigation sensor (50) into coordinates for each line image (S14), and then successively saves all the data in the line buffer or the memory which is not shown on the diagram (S16);

At the next step is stitching line images (S20), in which the control unit reads the line images and coordinates stored in the line buffer, and projects the line images onto the corresponding coordinates by each predefined area (S22). The control unit now stitches line images based on calculated coordinates to create tile images (S24), and successively saves tile images in accordance with designated coordinates in the tile buffer (S26);

The whole process is completed by stitching the tile images (S30), where data previously generated are positioned with corresponding coordinates to create a full image.

The method hereto according to the related art involves a tremendous number of computations for image stitching. To fulfill such a task, the control unit must be high-performance and the memory capacity must be sufficient, which leads to an increase in manufacturing cost.

Also, the navigation sensor (50) must keep the margin of errors at the lowest level possible: this may alter productivity and increase fraction defective.

In addition, the scanning efficiency fairly drops due to a time-consuming process in which a scanner conducts image stitching several times to create a digital data. This also causes inaccuracy in positioning each one-dimensional image to generate a tile image.

Thus, there is need for a new technology, in which a control unit performs a reduced number of stitching images from a handheld scanner, while maximizing the precision of pixel-positioning, and minimizing the area that cannot be scanned due to the scanner structure.

### Disclosure

### Technical Problem

To resolve the above problems in the related art, an objective of the present invention is to create a handheld scanner device and the control method thereof where an optical image is scanned as multiple tile images in a particular size to reduce data processing while increasing the scanning speed.

Also, this invention aims at minimizing the area which cannot be scanned because of the blind spot between the housing and the image sensor. The introduction of a camera is desirable to capture such areas which the conventional method is unable to scan.

In the meantime, it also has an advantage to be able to remarkably cut the manufacturing cost down by using a normal camera rather than high-resolution one. This fact could benefit the visually handicapped from a user-friendly handheld scanner and the control method thereof.

### Technical Solution

The present invention, in the pursuit of such objectives, is to create a handheld scanner comprising a scanning part which captures tile images from an object and tracks down the distance, direction and rotation of the scanner movement;

and a control unit connected to the scanning part in which tile images are stitched to generate a page image based on signals of vertical synchronization, exposure, and light combined with relevant movement data;
and a control panel connected to the control unit to start and terminate scanning;
and an output part in response to a command either from the control panel or a computer which exports processed data in a matching form: text, audio or video;
and a memory connected to the control unit that saves tile images and movement data.
In this scanner, the scanning part has a window in which a transparent plate defines the size of scanning area;
and a housing which secures the window on the bottom thereof preventing penetration of external lights;
and a camera module mounted within the housing that scans tile images, at certain working distance from an object, by a preset array of pixels in rows and columns;
and a light source also placed inside the housing that illuminates an object for certain amount of time decided by the control unit;
and a navigation sensor located inside the housing that detects the distance and direction of the scanner movement to an approximal tile image. The navigation sensor comprises one or more of an optical mouse sensor, a ball mouse sensor, an acceleration sensor or a gyro sensor;
Preferably, two navigation sensors are separately installed from each other on the window and either at lower, middle or upper side.

In order to minimize afterimages induced from the movement of the scanning part, the synchronization signal and exposure time used in the scanner hereof are identical to those of common commercial cameras, while the illumination in response to the exposure time lasts for 2 ms or less;

The control unit activates the camera module to be exposed to an object for 2 ms or less with the light source in continual operation.

The control method for the present invention, wherein the device comprises:

a control unit connected to the scanning part in which tile images are stitched to generate a page image based on signals of vertical synchronization, exposure, and light combined with relevant movement data;
and a control panel connected to the control unit to start and terminate scanning;
and an output part in response to a command either from the control panel or a computer which exports processed data in a matching form: text, audio or video;
and a memory connected to the control unit that saves tile images and corresponding data;
is programmed with the following steps comprising; the first step begins when the control unit receives a command to scan, initializing all the variables including the distance, direction and rotation of the scanning part;
and at the second step, the control unit analyzes movement data on the distance, direction and rotation from the scanning part, and repeatedly verifies if an overlap between the current tile image and the previous tile image exceeds a particular size;
as the overlap being out of certain range, the third step transmits a signal for scanning and to the light source of the scanning part, and then captures a tile image along with movement data thereof on the distance, direction and rotation, which are then stored in the memory;
in case of no termination command received, the process returns to the second step;
otherwise it moves onto the fourth step if the control unit receives such a command in which tile images are stitched together.

Tile image stitching usually operates according to the following steps comprising; at the first step, the control unit initializes the variable n, allocating a buffer to save stitched images;

at the second step, the (n−1)-th and n-th tile images are loaded from the memory as well as the movement data on the distance and direction converted into coordinates;
then, the rotation of the n-th tile image is compensated based on the tilt derived from each coordinates from the two navigation sensors;
at the fourth step, the control unit performs a primary stitching in which the tile images are positioned at the corresponding coordinates;
at the fifth step, correlation algorithm is applied to complete micro-adjustments on the overlap between the (n−1)-th and the n-th tile images; the process returns to the second step when there is another tile image to stitch with the variable n increased by 1; otherwise it is terminated at the sixth step.

### Advantages

The present invention simplifies scanning process in which the handheld scanner stitches tile images directly captured from the scanning part. The advantage thereof lies on enhanced precision of positioning pixels and increase in data processing speed, especially on industrial purposes.

In addition, the present invention is able to approximate the size of the window that performs scanning to that of the housing, maximizing the scanning area when there is a physical disturbance to the scanner.

Furthermore, the present invention is able to scan uneven surfaces, and the size of the scanner can be reduced by means of an acceleration sensor and a gyro sensor of which mountings are adjustable.

Also, the present invention can be used by the visually handicapped without difficulty because of no limitation on scanning areas.

The present invention prevents penetration of any external light, and the micro-controlled exposure time reduces consequential afterimages to a minimum level, in order to enhance the quality of the scanned images. This also minimizes the power consumption required for the operation.

The present invention does not require high-resolution camera lens, auto focus, image stabilization, and backlight adjustment, which can lower manufacturing cost.

It also utilizes digital image processing to stitch tile images directly scanned from a common camera to eliminate the unnecessary data processing.

The present invention is beneficial to the visually handicapped since it is able to scan uneven objects without any need to focus and any disturbance caused by external light.

Through the present invention, fraction defective can decrease and productivity can be enhanced due to the reduced number of data processing in which the camera directly captures an object in the form of tile images.

The present invention can be operational under an average-performance control unit and lower the memory capacity thereof thanks to the decreased number of computations in which an object is scanned as tile images, saving certain manufacturing cost as well.

### DESCRIPTION OF DRAWINGS

Having thus described the invention in general terms, reference will now be made to the accompanying drawings, which are not necessarily drawn to scale, and wherein:

FIG. 1 is a diagrammatic view illustrating the components of a handheld scanner according to the related art.

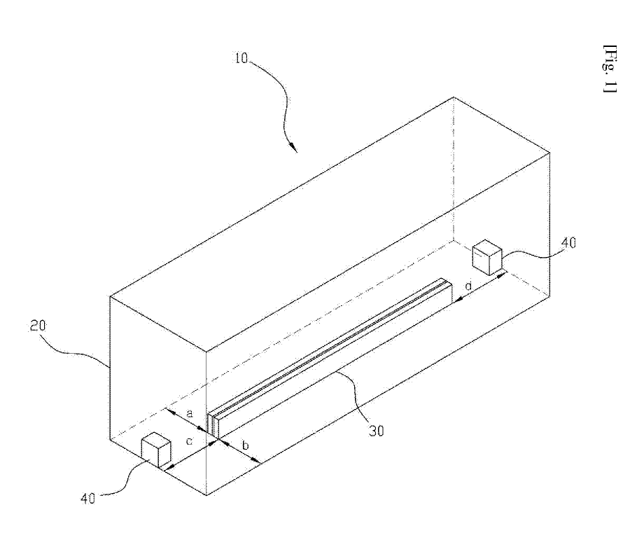

FIG. 2 is a flowchart in which a handheld scanner processes scanned image data according to the related art.

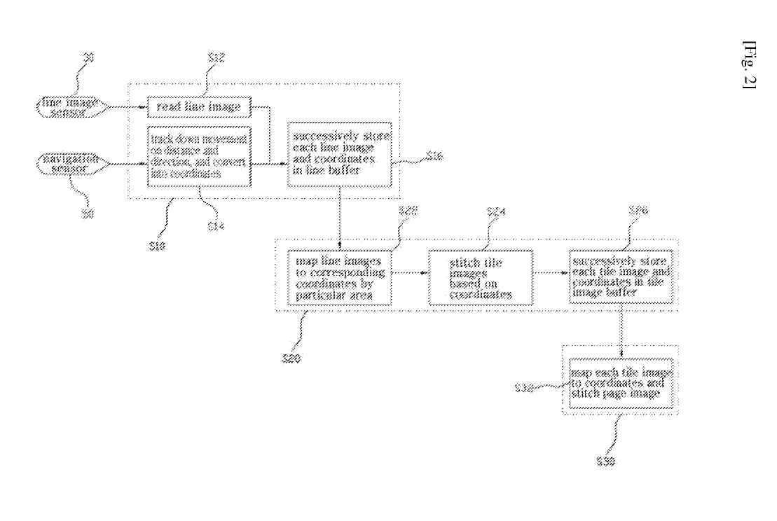

FIG. 3 is a diagrammatic block of the parts of a handheld scanner according to an embodiment of the invention.

FIG. 4 is a diagrammatic view demonstrating the components of the scanning part of FIG. 3 according to an embodiment of the invention.

FIG. 5 is a timing chart in which the light source is controlled during the constant exposure signal, according to an embodiment of the invention.

FIG. 6 is a timing chart in which the exposure signal is controlled with the light source constantly turned on, according to an embodiment of the invention.

FIG. 7 is a flowchart in which a handheld scanner processes scanned image data according to an embodiment of the invention.

FIG. 8 is a schematic view illustrating the status of images during stitching according to an embodiment of the invention.

FIG. 9 is a flowchart of a control method for a handheld scanner device according to an embodiment of the invention.

FIG. 10 is a flowchart of the process for tile image stitching to create a page image.

### MODE FOR INVENTION

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention. In addition, any explanations or diagrams which may stray from the main idea of the invention are excluded to avoid unnecessary confusion.

A digital camera captures an image by frame; a frame comprises an array of pixels in rows and columns; the vertical synchronization signal regulates the successive activation of the whole pixels and the horizontal synchronization signal regulates the horizontal activation of linear pixels.

The exposure time indicates the length of time during which an object is captured under control of the horizontal synchronization signal; and the light time is the length of time during which the light source illuminates the object when there is insufficiency in light.

Normally, the longer the light time is, the clearer the captured image becomes because of abundance in light. However, an object in motion leaves afterimages in this case.

There exist two types of control method for a digital camera; a rolling shutter controls the exposure time of successive linear arrangements of pixels; and a global shutter equally controls the exposure time of all the linear arrangements of pixels at a time.

The rolling shutter has simplicity in the control and in the configuration thereof, but blurs snapshots. On the other hand, the global shutter has complexity in the control and in the configuration thereof but is able to create a clear snapshot.

In lightless circumstances, a camera identifies the image data on the reflected light which has originally been emitted from the light source. The controlled light time herein can enhance the definition of the captured image.

In a digital camera, the exposure signal is the length of time in which the device captures an object, and the light signal is the length of time in which the light source illuminates the object.

The linear arrays of pixels which capture an object by frame involve a vertical synchronization signal that successively regulates vertical activation of the pixel arrangements, and a horizontal synchronization signal that regulates sequential activation of the pixel arrangements.

That is, a digital camera captures an image when the device is activated with both vertical and horizontal synchronization signals.

Generally, the longer the light signal is, the clearer the captured image can be due to abundant lights, whereas an object in motion leaves afterimages.

In the description of the invention, scan is synonymous with capture as being contextualized properly by the reader. Further, overlap is synonymous with superimposition as being contextualized properly by the reader.

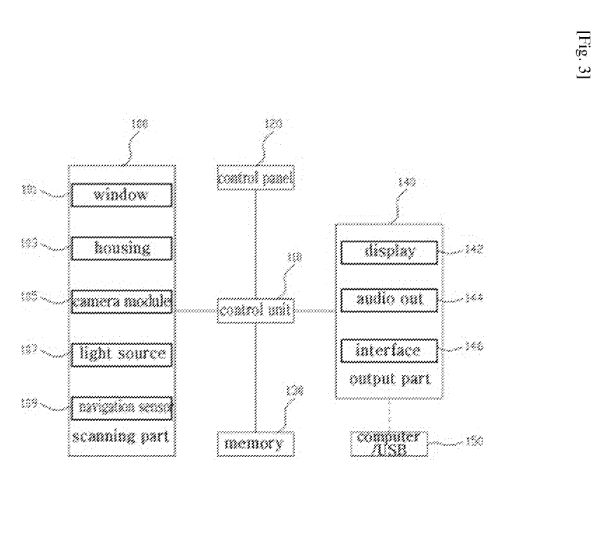

FIG. 3 is a diagrammatic view illustrating the components of a handheld scanner according to an embodiment of the invention.

Referring to the accompanying drawing in detail, the handheld scanner includes a scanning part (100), a control unit (110), a control panel (120), a memory (130), an output part (140), and a computer or USB memory (150).

The scanning part (100) consecutively captures tile images while travelling across the surface on an object and calculates movement data on the distance, direction and rotation. The scanning part (100) comprises a window (101), a housing (103), a camera module (105), a light source (107), and a navigation sensor (109);

The window (101) defines a scanning area of a tile image from an object or an image (referred to as an ‘object’ hereinafter), and is made of a transparent material;

The housing (103) secures the window (101) on the bottom thereof and prevents penetration of any external light;

The camera module (105) mounted within the housing (103) captures tile images through the window as being exposed to the array of vertical and horizontal pixels, ensuring a particular working distance between the camera module (105) and the object;

That is, the control unit (110) regulates the operation; the light signal allows the light source (107) to illuminate an object; and the camera module (105) scans the object through the window (101) by tile image in response to the exposure signal;

The light source (107) mounted within the housing (103) illuminates an object for certain length of time in response to the light signal from the control unit (110).

The navigation sensor (109) placed inside the housing (103) tracks down the movement of the scanning part(100) on the distance, direction and rotation until the device reaches the next tile image; and the navigation sensor (109) is equipped with either one or more of an optical mouse sensor, a ball mouse sensor, an acceleration sensor or a gyro sensor, preferably two of which are separately placed from each other on the window(101), of which mounting may be either at upper, middle or lower side;

That is, the navigation sensor (109) can be plural, two of which are desirable so as to ensure accuracy of the movement data derived from the device. Further, a ball mouse sensor and an optical mouse sensor are recommended to be mounted on the bottom, whereas an acceleration sensor and a gyro sensor have adjustable positioning thereof.

The control unit (110) connected to the scanning part (100) transmits synchronization signals, an exposure signal and a light signal, captures tile images along with the movement data on the distance, direction and rotation, and then stitches tile images in order to produce a complete page image.

When the scanning part (100) travels and the camera module (105) inside the housing (103) captures an image, it is to minimize unavoidable afterimages that the control unit (110) sends out a light signal to the light source (107) to illuminate an object for 2 ms or less, while utilizing a vertical synchronization signal and an exposure signal identical to those of a common camera.
In another example, the control unit (110) with the light source (107) in operation allows the camera module (105) to perform scanning under the exposure signal for 2 ms or less;

As power supplied, the control unit (110) initializes every variable (parameter) including the variable n, regulating each part by means of digital signals.

In response to a start command from the control panel (120), the control unit (110) activates the scanning part (100) comprising the camera module (105), the light source (107) and the navigation sensor (109); and the camera module (105) scans an image as the vertical synchronization signal being synchronous to the exposure signal (horizontal synchronization signal);

The camera module (105) begins scanning when receiving both the vertical synchronization signal and the exposure signal (horizontal synchronization signal) to scan an image in a working distance, converting it into a digital signal;

The working distance indicates a distance from an object to the focal length of the camera module (105). In this case, the camera module (105) is able to scan an object which is slightly out of the working distance.

The control unit (110) transmits the light signal synchronous with the vertical synchronization signal to the light source (107). The navigation sensor (109) under control of the control unit (110) exports movement data on the distance and the direction in accordance with the vertical synchronization signal;

The control unit (110) processes the movement data generated from the navigation sensor (109), verifies if the overlap between the current tile image and the previous (n−1) tile image exceeds certain size, and resends out the exposure signal to the camera module (105) and the light signal to the light source (107) to capture a new (n) tile image at the current position;

And the captured tile image designated with the relevant the movement data is saved in an allocated buffer of the memory (130), repeating such a process as the variable n is updated.

Receiving a termination command through the control panel (120), the control unit (110) deactivates the scanning part (100) and conducts a primary stitching while compensating any slopes (tilts) including rotation and movement on direction and distance of the tile images based on the movement data; then, the control unit (110) performs micro-adjustments on the overlap by applying the correlation algorithm, which is the secondary stitching;

That is, the multiple tile images are stitched together through a primary and a secondary stitching process, so as to form a page image.

The control unit (110) saves and regulates each tile image and stitched tile images in an allocated buffer of the memory (150).

As image stitching completed, the control unit (110) can perform optical character recognition (OCR), language translation and text-to-speech (TTS) in response to a command received through the control panel (120) or a computer (150), and transfers the output data to each corresponding component of the output part (140).

The control panel (120) connected to the control unit (110) comprises multiple buttons (keys), each of which sends a command for either start and termination of scanning, optical character recognition (OCR), language translation, or text-to-speech (TTS).

The memory (130) connected to the control unit (110) comprises ROM, RAM etc., in which the tile images, movement data and stitched page images are stored. It also functions as a memory buffer.

The output part (140) exports the data processed from the control unit (110) in either matching form of text, audio or video. It comprises a display (142), an audio out (144), and an interface (146) (I/F: interface);

The display (142) visualizes the data of tile images or stitched page images regulated by the control unit (110). It also converts the textual data into the acoustic signal exported through the audio out (144) as an audible sound for the user;

The interface (146) imports and exports tile images, stitched page images, converted texts, converted acoustic data etc. interacting with external devices. For instance, the interface (146) is able to be connected to several peripheral devices such as a computer (160), a USB (Universal Serial Bus) memory, or a monitor, so as to export the data in a matching form. In case of a computer (160), diverse applications are available to regulate the control unit (110) and customize variables (parameters).

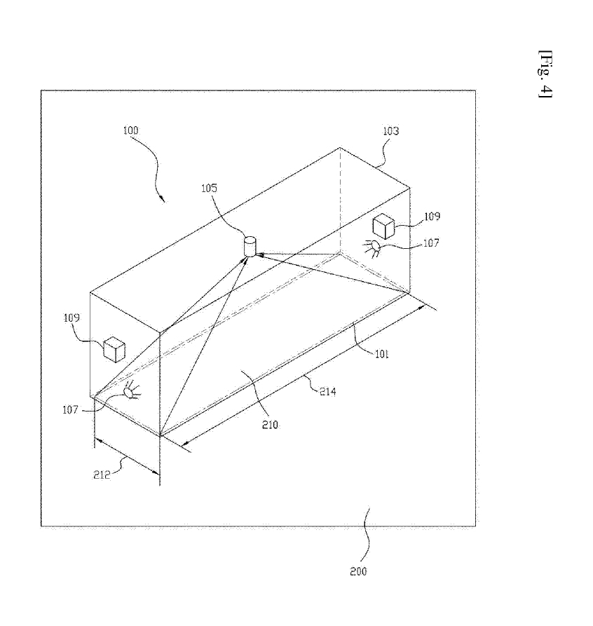

In an embodiment of the present invention, FIG. 4 is a structural diagram which illustrates the scanning part (140) in detail according to FIG. 3.

Referring to the accompanying drawing in detail, the scanning part (100) consists of a window (101), a housing (103), a camera module (105), a light source (107), and a navigation sensor (109).

The window (101) slides on the surface of an object (200), defining the size of a scanning area (210).

In an embodiment of the present invention, the window is made of a transparent material, with the approximated size thereof to that of the housing (103) in order to minimize the blind spot when the scanning part (100) encounters any physical disturbance such as binding or wrinkles;

When the scanning part (100) travels onto a page of a book, it becomes unable to continue scanning when an end of the housing (103) reaches the binding. At this point, the space between the end of the housing (103) and the scanning area (210) unavoidably results in a blind spot where scanning is impossible;

The advantage of the present invention is highlighted in that this method can minimize such blind spots whereas the conventional scanner has to separate the line image sensor from the housing at a certain distance, consequently creating a blind spot.

The housing (103) blocks any penetration of external light sources to the camera module (105), and functions as chassis (frame) in which the camera module (105), the light source (107), and the navigation sensor (109) are properly mounted;

Thus, no external light is introduced inside the housing (103) and the camera module (105) completely relies on the light emitted from the light source (107) during scanning.

The camera module (105) is ensured certain working distance from an object (200) visible through the window (101), and mounted on a designed position inside housing (103) to capture a tile image within the scanning area (210). The camera module (105) consists of elements such as CMOS or CCD, and is activated by the vertical synchronization signal and the exposure signal from the control unit (110) to capture a tile image on the scanning area (210).

The window (101) defines an area in a particular width and length, allowing the camera module (105) to scan one tile image at a time;

The present invention significantly increases scanning efficiency and precision of pixel-positioning on a tile image, in comparison with the conventional method where the line image sensor captures an image by a linear pixel group, which is equivalent to a width of a tile image in the present invention.

A working distance is a linear distance from either the window (101) or an object (200) to the focal length of the camera module (105). In the meantime, the camera module (105) under control of the control unit (110) is able to capture an object (200), which is somewhat out of reach of the working distance (200).

When the camera module (104) captures a tile image area (210) defined by the window (101), it is considerably advantageous that this method is able to scan a larger area at a time than the conventional line image sensor, and precisely captures tile images near a binding of a book.

The light source (107) is mounted at certain location within the housing (103) to supply lights to an object (200). Although it can be equipped with an LED or a lamp, the light source is recommended to comprise a particular type of LED, which provides a compact size, high power density and super brightness so as to emit a sufficient amount of light at low power consumption.

This LED can contain plurality in the structure in order for the camera module (104) to capture an object. The light source illuminates an object in response to a light signal from the control unit (110). The mounting thereof should take into account the position in which the entire scanning area (210) receives an equal intensity of illumination.

In an attempt to minimize afterimages when the scanning part (100) slides onto an object to consecutively capture tile images, the light source (107) emits light for a very short length of time or ceases illuminating quickly, in accordance with a light signal from the control unit (110). By means of the operation herein, high-definition tile images can be obtained without notable afterimages. This is also one of the advantages which the present invention provides.

Comprising one or more of an optical mouse sensor, a ball mouse sensor, an acceleration sensor or a gyro sensor, the navigation sensor (109) exports the data on the distance, direction and rotation of the scanning part (100);

The navigation sensor (109) can be mounted either at upper, middle, or lower side of the housing (103);

In an embodiment of the present invention, an optical mouse sensor or a ball mouse sensor, if chosen, transmits a digital signal for easy data processing, but has a disadvantage in that the sensor must be mounted on the bottom of the housing (102), lower side, in order for the sensor to contact an object, the bottom surface must be comparably large, and the sensor becomes unable to export the movement data when it strays from the extent of an object;

The use of an acceleration sensor or a gyro sensor permits the mounting thereof to be customized. However, the exported signal is analogue so that it requires an additional complex processing.

The sensor works even without directly touching an object because of adjustable mounting position, enabling the scanning part (100) to shrink for improved portability. It also allows scanning when the sensor strays from the range of an object, enlarging the scanning area;

For enhanced accuracy of the movement data, it is desirable to install multiple navigation sensors (109), preferably two of which are separately positioned from each other inside the housing (103).

The housing (103) can have two separate flames: one for anti-penetration of external light sources, and the other for mounting the navigation sensor (109).

Under control of the control unit (110), the scanning part (100) described above captures tile images by scanning area (210) when working on an object;

Scanning an object (200) by tile image area (210), the present invention improves the speed and accuracy of the process in comparison with the conventional method which depends on the line image sensor (30), a linear pixel arrangement;

The control unit activates the scanning part (100) to consecutively capture tile images from scanning areas (210) while sliding on an object, and the navigation sensor (109) to export the movement data. Then it stitches tile images according to the coordinates derived from the movement data to create a page image.

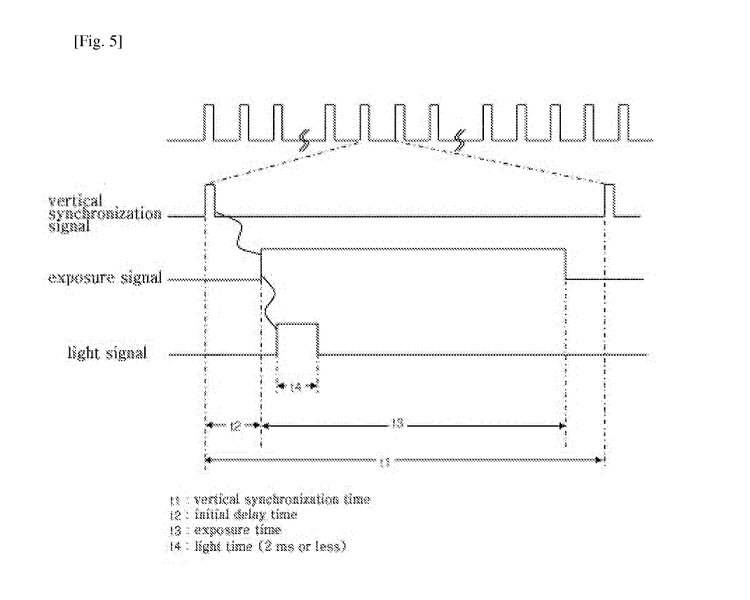

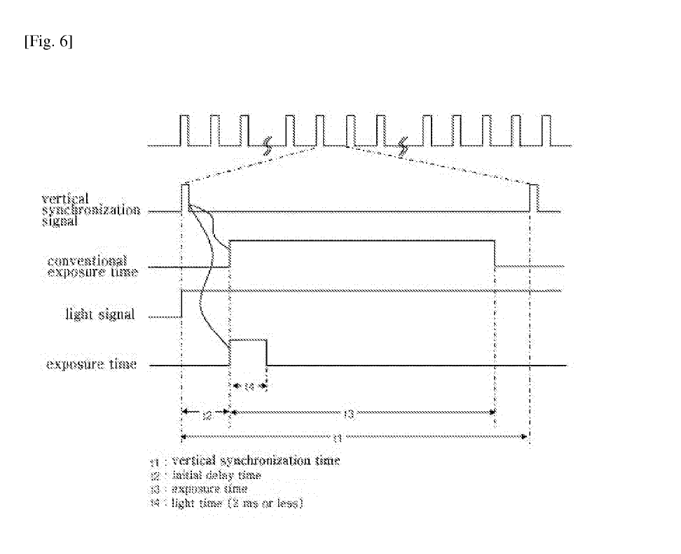

In an embodiment of the present invention, FIG. 5 is a timing chart that illustrates the regulation of the light signal along with the general exposure signal. FIG. 6 in another embodiment of the present invention is a timing chart in which the exposure signal is controlled while the light source is continuously turned on;

Referring to the accompanying charts in detail, FIG. 5 and FIG. 6 relate to an embodiment of the present invention in which the reduced length of time that the image sensor is exposed minimizes afterimages when the scanning part (100) slides on an object.

An image falls on each pixel constructing the camera when there are both the vertical synchronization signal and the horizontal synchronization signal (exposure signal).

Generally functioning for the camera module (105), the vertical synchronization signal activates the frame image (corresponding to the tile image herein) of the camera module (105), and the exposure signal is a signal during which an image falls on the image sensor.

As the vertical synchronization signal applied, followed by certain delay (t2), the exposure signal is activated for the exposure time (t3) during which an image keeps falling on the image sensor, producing afterimages as many as the exposure time (t3) multiplied by the sliding speed of the scanning part (100).

The length of induced afterimages can be deduced by the following equation.

ΔL=v*t3 [Equation]

Here, (v) represents the speed (mm/sec), (t3) the exposure time (second), and (ΔL) the length of afterimages (mm).

In order to minimize such afterimages, the exposure time (t3) should be decreased given the fact that the speed (v) totally relies upon the user.

(t1) refers to the vertical synchronization time, the length of time to capture one frame image (tile image herein).

The light signal in the present invention is transmitted by the control unit (110) to supply necessary light from the light source (107) when the camera module (105) inside the housing (103) is operational.

The present invention provides two operation modes: snapshot mode and consecutive shot mode. The snapshot mode exports a control signal for camera module (105) to work only when needed. The consecutive shot mode activates the camera module (105) at certain frequency, only saving a desired image while the rest are discarded;

The movement data from the navigation sensor (109) is used to decide when to capture, which will be described in detail afterwards.

Still referring to FIG. 5, the vertical synchronization time (t1) and the exposure time (t3) of the camera module (105) are identical to those of a common camera, whereas the light time (t4) of the light source (107) is minimized in order for the exposure time (t3) to be minimized in which inside the housing (103) is a complete darkness with the light source (107) turned off.

FIG. 6 demonstrates how to minimize the exposure time (t3) alone of the camera module (105).

Thus, it is desirable that the light is abundant for a very short length of time.

For example, the handheld scanner travelling at a speed of 50 mm/sec, as the exposure time (t4) being preset at 2 ms produces afterimages at a length of L=v * t4=50 * 0.002=0.1 (mm);

The scanner at a speed of 50 mm/sec herein travels as far as a width of an A4 sheet within 4 seconds.

In newspapers, a stroke of a character measures about 0.25 mm, of which 0.1 mm approximately takes up to 40% allowing the device to perform character recognition without difficulty. The shorter light time (t4) is, the shorter afterimages become.

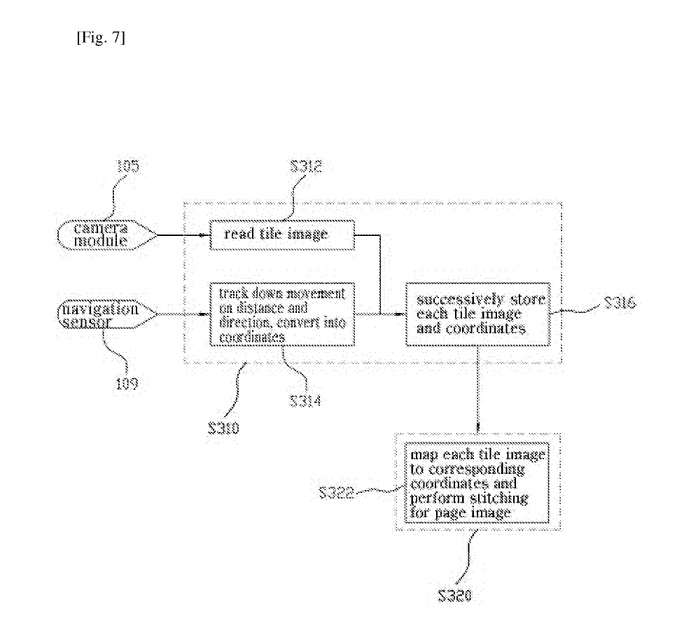

In an embodiment of the present invention, FIG. 7 is a flowchart of processing scanned image data;

Referring to the accompanying drawing in detail, the procedure of data processing consists of two steps: scanning (S310) and stitching (S320);

At the scanning step (S310), the camera module (105) by means of the vertical and horizontal pixels thereof captures a tile image (S312) by certain width (212) and length (214). The navigation sensor (109) exports movement data on the distance, direction and rotation, converting the result into coordinates (S314). Then all the information is successively stored in the tile image buffer (S316);

At the stitching step (320), a page image (S322) is completed through stitching tile images based on the coordinates saved in the tile image buffer;

The current invention is exempt from line image stitching in which the conventional method slows data processing down;

In addition, the number of systematical errors can be significantly decreased due to the reduced number of data processing, and the precision of pixel positioning can be improved.

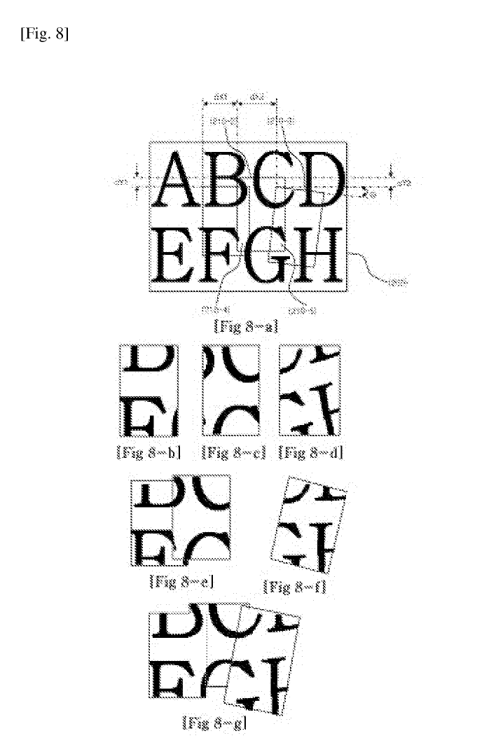

In another embodiment of the invention, FIG. 8 is a diagram that indicates the steps when stitching scanned tile images.

Referring to the accompanying drawing in detail, the scanning part (100) slides on an object (200) to capture an image at the scanning step (S310), for which FIG. 8-a indicates the first scanned area (210-1), the second scanned area (210-2), and the third scanned area (210-3);

The second scanned area (210-2) is captured having travelled dX1 horizontally and dY1 vertically from the first scanned area (210-1);

The third scanned area (210-3) is captured having travelled dX2 horizontally and dY2 vertically, and rotated θ from the second scanned image (210-2);

In addition, the overlaps (210-4) and (210-5) are created between each scanned area at a particular size, which is considered practical in stitching;

The overlaps play a key role in micro-adjustments in order for the stitched page image to be exact at the stitching step (S320).

The control unit (110) takes into account the movement data exported from the navigation sensor (109), and continuously verifies if the overlap between the previous tile image (n−1) and the current tile image (n) exceeds certain predefined size to conduct scanning.

FIG. 8-b, FIG. 8-c, and FIG. 8-d demonstrate tile images of the first scanned area (210-1), the second scanned (210-2), and the third scanned area (210-3) respectively (referred to as Tile Image-1, Tile Image-2, and Tile Image-3 hereinafter).

At the stitching step (S320), each tile image is stitched through mapping on the coordinates. Stitching involves the primary stitching only utilizing the coordinates and the secondary stitching for micro-adjustment by means of correlation algorithm.

FIG. 8-e shows a stitched image by mapping Tile Image-2 having been relocated by dX1 horizontally and dY1 vertically from Tile Image-1.

FIG. 8-f demonstrates Tile Image-3 rotated by θ.

FIG. 8-g is a diagram illustrating that, through mapping, Tile Image 3 is stitched having been travelled dX1+dX2 horizontally and dY1+dY2 vertically and rotated by θ to the previously stitched image according to FIG. 8-f.

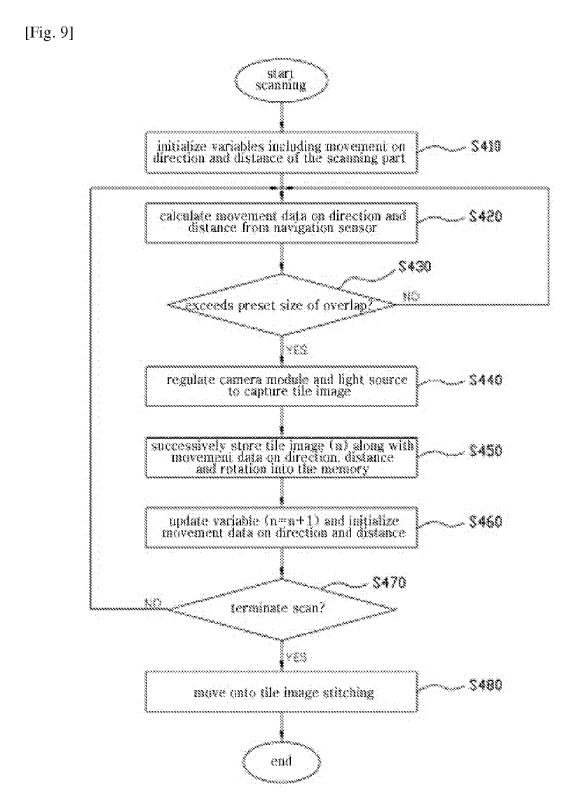

In an embodiment of the present invention, FIG. 9 is a flowchart of the control method of the handheld scanner.

Referring to the accompanying drawing in detail, the control unit (110) initializes the variables (parameters) (S410), such as the movement data from the scanning part (100), saved in the memory (150) once power supplied and a command received to commence scanning from the control panel (120);

The control unit then transmits a light signal to the light source, and the scanning part (100) slides on an object to scan the tile images. The captured tile image is referred to as the (n−1)-th tile image, which is successively saved in the memory combined with the movement data including the distance, direction and rotation;

The control unit analyzes the movement data of the (n−1)-th tile image from the scanning part, monitoring if the processed data thereof is out of reach of an overlap predefined for the (n−1)-th tile image (S420);

Then, the control unit verifies if the current position of the scanner strays from the range of a preset overlap of the (n−1)-th tile image (S430);

In case where the overlap is not exceeded, the system returns to the process (S420), which constantly repeats such verifications;

As the overlap strayed from a particular size, the control unit reactivates the scanning part including the camera module and the light source to scan a new tile image (S440).

The tile image herein is referred as the (n)-th tile image.

The control unit successively saves the (n)-th tile image along with the corresponding movement data including the distance, direction and rotation from the navigation sensor in the buffer of the memory (S450);

In the meantime, the control unit increases the variable n in by 1 (n=n+1) and initializes the variables of the movement data on the distance, direction and rotation (S460);

When there is no termination command from the control panel, the control unit returns to the process (S420) to capture a new tile image as well as to track down the movement data (S470);

Having received a termination command, the control unit ends the entire process by stitching successively saved tile images along with the coordinates thereof to complete a page image (S480).

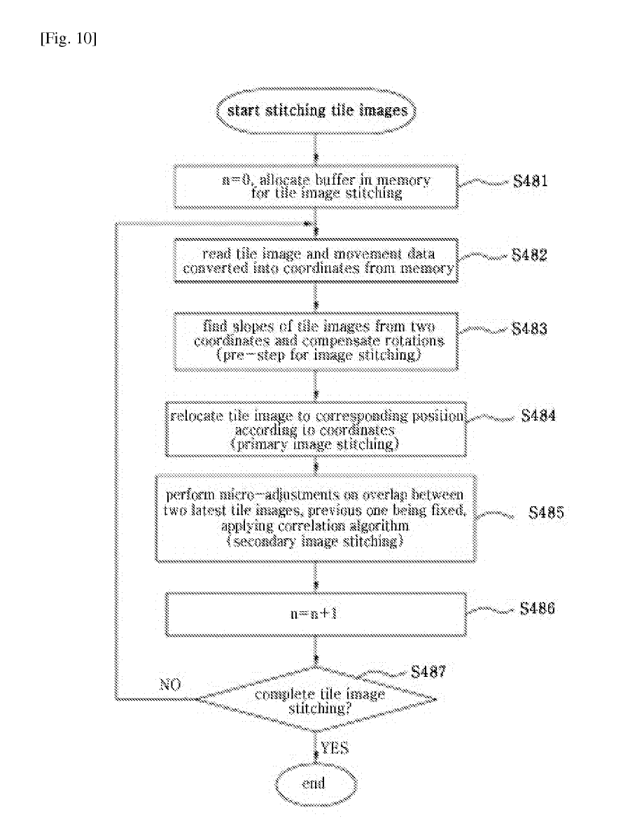

FIG. 10 is a flowchart that illustrates the procedure of stitching tile images to form a page image.

Referring to the flowchart in detail, the control unit initializes the variable n and allocates an area or a buffer of the memory for page image stitching (S481);

The control unit loads the tile images, the (n−1)-th and the n-th, along with the corresponding movement data, converting them into coordinates (S482);

Then, the control unit compensates any rotation of each tile image based on the coordinates above (S483);

The primary stitching is completed by mapping the tile images to each designated coordinates (S484), for which rotations have been compensated;

With regards to the primarily stitched image, correlation algorithm is applied to perform micro-adjustments on the overlap between the previous tile image and the current tile image (S485). This process is called the secondary stitching;

The control unit increases the variable n by 1 (S486), and returns to the process (S482) in case of more tile images left to scan, or terminates scanning (S487).

Composed of the parts described so far, the present invention is advantageous in that it minimizes the blind spot caused by the gap between the scanning area and the bottom of the scanning part, in which the present invention approximates the size of the bottom of the housing to the scanning area.

The acceleration sensor allows the scanner to capture an image even out of range of the scanning area, with the adjustable mounting thereof for a reduced size of the device.

In addition, the present invention scans an object by tile image, in which the pixels thereof are fixed, for higher precision of pixel-positioning on tile images and faster processing of data than the conventional method.

As power supplied only when scanning a tile image, the power consumption is minimized by means of the light source which illuminates for a very short length of time.

The present invention is not in need of a high-resolution camera, auto-focus, image stabilization or backlight adjustment which leads to a lowered manufacturing cost.

While the conventional method has limitation for use even with a high-resolution camera and such additional functions, the present invention perfectly performs scanning, allowing the visually handicapped to be beneficial.

Many modifications and other embodiments of the inventions set forth herein will come to mind to one skilled in the art to which the present invention pertains having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A handheld scanner device comprising:
a scanning part for scanning an object by tile image wherein the pixels are arranged in rows and columns, and wherein the movement data on the direction, distance and rotation are exported when the device travels on the object;
and a control unit, to which the scanning part is connected, for stitching tile images in accordance with the movement data above to complete a page image;
wherein the scanning part comprises:
a camera module ensured certain working distance from an object, in which tile images are captured;
and a navigation sensor which tracks down the movement of the scanner.

2. The handheld scanner device according to claim 1, wherein the scanning part comprises:
a window defining an area of a tile image to be scanned, made of a transparent material;
and a housing to prevent penetration of external lights, wherein the window is mounted on the bottom thereof;
wherein the camera module is secured inside of the housing.

3. The handheld scanner device according to claim 2, wherein the scanning part further comprises:
a light source mounted within the housing to illuminate an object in response to a light signal from the control unit.

4. The handheld scanner device according to claim 2, wherein the size of the window is close to that of the bottom of the housing.

5. The handheld scanner device according to claim 2, further comprising:
a control panel connected to the control unit that sends commands for start and termination of scanning;
and an output part in response to a command either from the control panel or a computer which exports tile images stitched by the control unit, or in a transformed form: text, audio or video;
and a memory connected to the control unit for storage of tile images and movement data;
and a navigation sensor equipped with one or more of an optical mouse sensor, a ball mouse sensor, an acceleration sensor, or a gyro sensor, preferably two of which are separately mounted from each other, and at either upper, middle or lower part of the housing.

6. The handheld scanner device according to claim 3, wherein the control unit transmits a light signal to the light source illuminating for 2 ms or less, in order to minimize afterimages when the camera module captures an image for which the scanning part is in motion.

7. The handheld scanner device according to claim 3, wherein the control unit regulates an exposure signal so as the camera module to capture an image for 2 ms or less, with the light source constantly turned on.

8. The method for controlling the handheld scanner device, wherein the device comprises:
a scanning part which travels on the surface of an object to consecutively capture tile images and export the movement data thereof;
and a control unit, to which the scanning part above is connected, which regulates signals for vertical synchronization, exposure and light, as well as completes a page image through stitching tile images;
and a control panel which turns in a scanning command to the control unit;
and an output part in response to a command from the control panel or a computer, which exports data in a matching form: text, audio, or video;
and a memory connected to the control unit in which the processed images and movement data are saved;
wherein the control method of the device comprises the steps of:
initializing the variables including movement data on the distance, direction and rotation of the scanning part, once the control unit approves scanning;
and verifying if the overlap between the two latest scanned tile images strays from the predefined area based on the movement data on the distance, direction, and rotation derived from the scanning part;
and scanning a tile image in response to a scanning signal and a light signal into the scanning part as the overlap having been exceeded, then successively saving image data along with corresponding movement data in an allocated buffer of the memory;
and returning to the verifying step without a termination command, otherwise stitching the scanned tile images.

9. The method according to claim 8, wherein stitching tile images comprises the steps of:
initializing the variable n and allocating buffers to save images under control of the control unit;
and converting movement data of the (n−1)-th and n-th tile images saved in the memory into coordinates;
and compensating the rotation based on the tilt identified by the two respective coordinates above;
and stitching the tile images through mapping onto the corresponding coordinates;
and performing micro-adjustment on the overlap between the (n−1)-th and n-th tile images by means of correlation algorithm;
and returning to the converting process in case where the control unit, increasing the variable n by 1, detects more images to stitch, otherwise terminating the process.
